(19) United States
(12) Patent Application Publication
(10) Pub. No.: US 2009/0315221 A1
(43) Pub. Date: Dec. 24, 2009

(54) METHOD FOR DEMOLDING CERAMIC PRODUCTS AND APPARATUS FOR IMPLEMENTING THE METHOD

(75) Inventor: GIORGIO SARANI, BORGO TOSSIGNANO (IT)

Correspondence Address: Pearne & Gordon LLP, 1801 East 9th Street, Suite 1200, Cleveland, OH, 44114-3108, US

(73) Assignee: SACMI COOPERATIVA MECCANICI IMOLA SOCIETA' COOPERATIVA, 40026 IMOLA (BOLOGNA) (IT)

(21) Appl. No.: 12/483,274

(22) Filed: Jun. 12, 2009

(30) Foreign Application Priority Data
Jun. 18, 2008 (IT) BO2008A000387

(51) Int. Cl. B28B 7/10; B28B 7/12

(52) U.S. Cl. 264/335; 264/334

(57) ABSTRACT

A demolding method for extracting a ceramic product (1) from a half-part (2) of a mold comprises at least the following steps: positioning an extractor element (3), which has a contact surface (3s), at a visible surface (1a) of the product (1) partially housed in the mold half-part (2); extracting the product (1) and placing it in abutment against the contact surface (3s); dividing the contact surface (3s) into two separate, matching portions (3a, 3b) by moving a first portion of it (3a), which supports the product (1), away from its other portion (3b); releasing the product (1) onto a work and/or supporting element or table (4) matchingly shaped to be coupled to the first portion (3a) of the extractor element (3); moving the first portion (3a) and the supporting element or work table (4) away from each other. The invention also relates to an apparatus that implements this method.

### BACKGROUND OF THE INVENTION

This invention relates to a method, and to an apparatus implementing the method, for demolding ceramic products, in particular products having a wide, substantially flat surface and whose dimensions in the direction perpendicular to said wide surface are small compared to the characteristic dimensions of the surface itself, such as, for example, shower trays, ceramic flush tank lids and ceramic plates for supporting other products to be fired.

As is well known, ceramic sanitaryware (such as washbasins, toilet bowls, bidets, shower trays and the like) is made by casting a fluid mixture (known as “slip” in the jargon of the trade, consisting of a ceramic body in aqueous suspension) in customary molds with a porous structure, made in particular from resins.

These porous molds are composed of at least two parts (usually known as “male” and “female” in the jargon of the trade) which are joined to form an internal cavity where the ceramic product is formed.

After being cast, the product is extracted from the mold (by opening the two parts of the mold), this extraction step being also referred to as demolding, and being usually performed by mechanical, servo-assisted or robotic apparatus.

Current methods for demolding ceramic products having a wide, substantially flat surface and whose dimensions in the direction perpendicular to said wide surface are small compared to the characteristic dimensions of the surface itself, can be broadly divided into the following two types: vertical demolding and horizontal demolding (where “vertical” and “horizontal” refer to the position of the mold part and of the product during extraction).

In a first form of vertical demolding, the extraction apparatus consists of a group of suction cups associated with a movement unit and passing through openings made in a tray which supports the product and which is also used to transport the product during subsequent steps in the production process where the product is fettled and finished.

The suction cup unit thus grips the product in the vertical position by its exposed surface (usually the less “noble” one, that is to say, the surface that is hidden when the finished product is eventually assembled) using vacuum generating means located on the movement unit. Once the product has been extracted from the mold part and placed against the tray, the entire assembly, made up of product, tray and suction cups, is turned to the horizontal position and the tray with the product on it is placed on suitable tables where the product is left to dry.

That is because the product is extracted from the mold in a solid but “green” state (when the percentage by weight of its water content is still high) and it is thus still subject to plastic deformation: therefore, before being further processed, the product must be allowed to dry for a relatively long period of time.

This demolding method has a several shortcomings due not only to the constructional architecture of the suction cup unit but also to the use of the tray.

Generally speaking, a single batch of products to be demolded from the same casting machine includes products of different sizes which must be demolded one after the other in rapid sequence. In a batch of shower trays, for example, there may be at least four different product sizes. That means the suction cup units must be made in such a way as to make uniform contact with different products or, where that is not possible, the suction cup units used must be or different types or made more complex (for example, with means for moving the suction cups to active or passive positions): this in turn means increasing the overall costs of the demolding apparatus.

Similarly, the trays must be adapted to the product on account of the centre distances of the suction cups in different dimensional versions of the demolding apparatus: in this case, too, the costs of the installation increase considerably.

Other drawbacks due to the presence of the tray in addition to the demolding apparatus are the following:

the large amount of storage space required for the trays;

the impossibility of carrying out finishing operations on the product while it is on the tray since the latter's surface area must be larger than that of the product, while, to enable the product to be finished (especially round the edges), its support must be smaller (which means the product must be further handled and moved onto other supports more suitable for finishing purposes);

the risk of creating a large number of scrap products on account of a non-uniform contact surface (owing to the presence of holes or openings necessary for the passage of the suction cups and for the passage of the air needed for drying) which “opposes” natural product shrinkage during drying, leading to friction and the risk of irremediably marking the less noble surface of the product.

In a second form of vertical demolding, extraction is performed by an extraction unit consisting of: a perforated supporting tray positioned on a rotatable flat frame forming, at the back, a closed chamber for generating a negative pressure through respective means located on the main supporting frame; an adjustable bottom bracket used to support the product during its extraction and rotation.

The tray and the frame are placed against the less noble surface of the product whose perimetric edges come into contact with the corresponding part of the tray, thus sealing the front to form a vacuum chamber and itself constituting the demolding means when the vacuum is generated. For this purpose, the back of the tray is provided with suitable frames for closing the perforations and coinciding with the perimetric dimensions of the product in order to optimize the seal during demolding.

This method, compared to the one described previously, has the advantage of standardizing, or at least reducing the number of trays needed, but still has the disadvantages due to the large amount of space occupied, the high cost of the auxiliary structures for the trays, the risk of creating a large number of scrap products and the impossibility of finishing the product while it is on the tray.

A third form of demolding is constituted, as mentioned above, by horizontal demolding. In this case, the mold part that holds the product may be made to rotate by a right angle in such a way as to place the product on the tray, which is moved by suitable apparatus. The product is extracted from the mold substantially by gravity when demolding means (water, air) are pumped into the mold in order to detach the product from the tray.

Although this method, too, like the previous one, overcomes the problem of the large number of different trays to match different product sizes and the problem of the suction cups, it also has disadvantages due to liquid collecting in the tray (after being used for demolding purposes) and causing the product to stick to the tray, with the risk of the product having to be scrapped, which is added to the problems of scrapping due to shrinkage, and the impossibility of finishing the product while it is on the tray.

### SUMMARY OF THE INVENTION

The aim of this invention is therefore to overcome the above mentioned disadvantages by providing a practical and quick demolding method for ceramic products that reduces the risk of damaging the products, that does not make use of trays and that is applicable in particular to products having a wide, substantially flat surface and whose dimensions in the direction perpendicular to said wide surface are small compared to the characteristic dimensions of the surface itself.

Another aim of the invention is to provide a demolding apparatus that implements said method and that is structured in such a way as to enable the product to be extracted and moved quickly and safely without using a traditional tray.

According to the invention, the above aim is achieved by a method for demolding ceramic products, in particular a method and apparatus for demolding products having a wide, substantially flat surface and whose dimensions in the direction perpendicular to said wide surface are small compared to the characteristic dimensions of the surface itself, comprising the technical characteristics set out in one or more of the appended claims.

### BRIEF DESCRIPTION OF THE DRAWINGS

The technical characteristics of the invention, with reference to the above aims, are clearly described in the appended claims and its advantages are apparent from the detailed description which follows, with reference to the accompanying drawings which illustrate a preferred embodiment of the invention provided merely by way of example without restricting the scope of the inventive concept, and in which:

FIGS. 1 to 5 illustrate a first embodiment of an apparatus according to this invention for demolding ceramic products, during different operating steps implementing a method for demolding the products, all these figures being schematic side views with some parts cut away and others in cross section, FIG. 3 being a view in a larger scale than the others;

FIG. 6 is a bottom plan view, with some parts cut away in order to better illustrate others, of the apparatus shown in the illustrations listed above;

FIG. 7 is a top plan view schematically representing an installation for making and finishing ceramic products, such as shower trays, using the apparatus and method illustrated in the figures listed above;

FIGS. 8 and 9 are schematic side views illustrating two different operating configurations of a second embodiment of the apparatus according to the invention, for demolding ceramic products.

### DESCRIPTION OF THE PREFERRED EMBODIMENTS

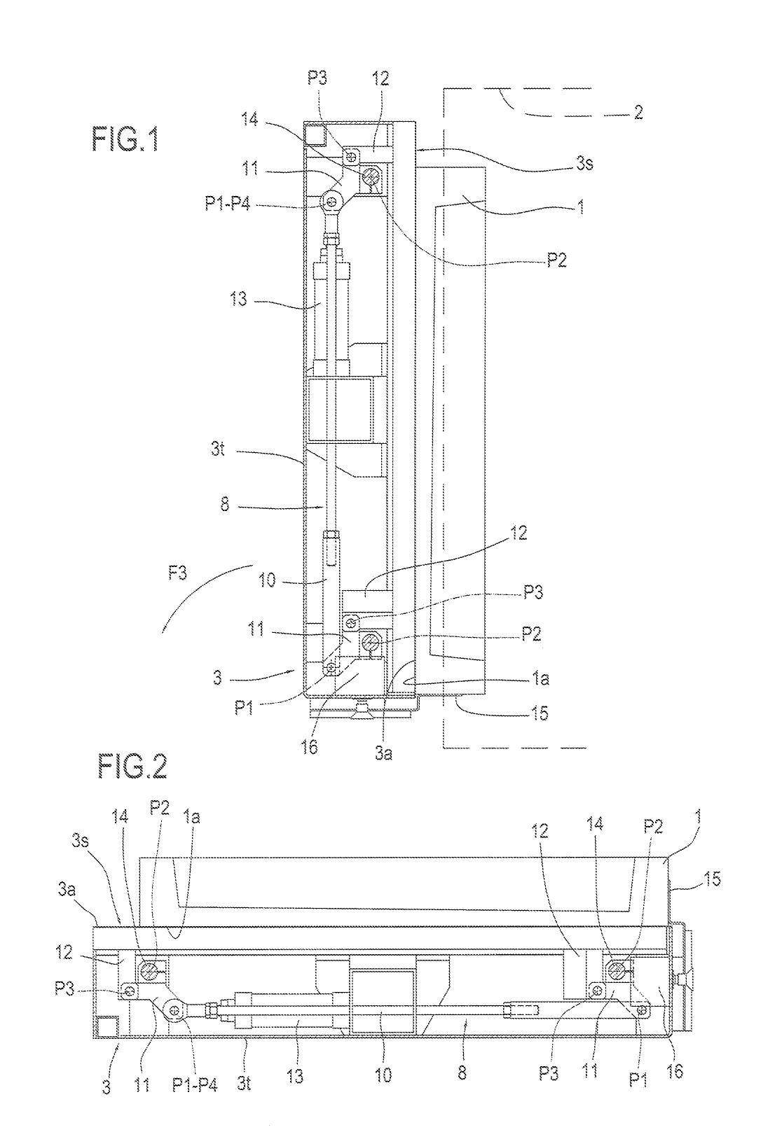

With reference to the accompanying drawings, and in particular FIGS. 1 to 5, this invention relates to a demolding method for extracting a ceramic product 1 from a half-part 2 of a mold and to an apparatus that implements said method.

In particular, but without limiting the scope of the invention, the products 1 to be demolded have a wide, substantially flat surface and dimensions in the direction perpendicular to said wide surface that are small compared to the characteristic dimensions of the surface itself, such as, for example, shower trays, ceramic flush tank lids and ceramic plates for supporting other products to be fired.

As illustrated in FIGS. 1 to 5, the main demolding steps following the customary process of casting the product 1 in the mold are as follows:

positioning an extractor element 3, which has a contact surface 3s, at a visible surface la of the product 1 partially housed in the mold half-part 2 (see FIG. 1, where the half-part is drawn with a dashed line);

extracting the product 1 and placing it in abutment against the contact surface 3s (again see FIG. 1);

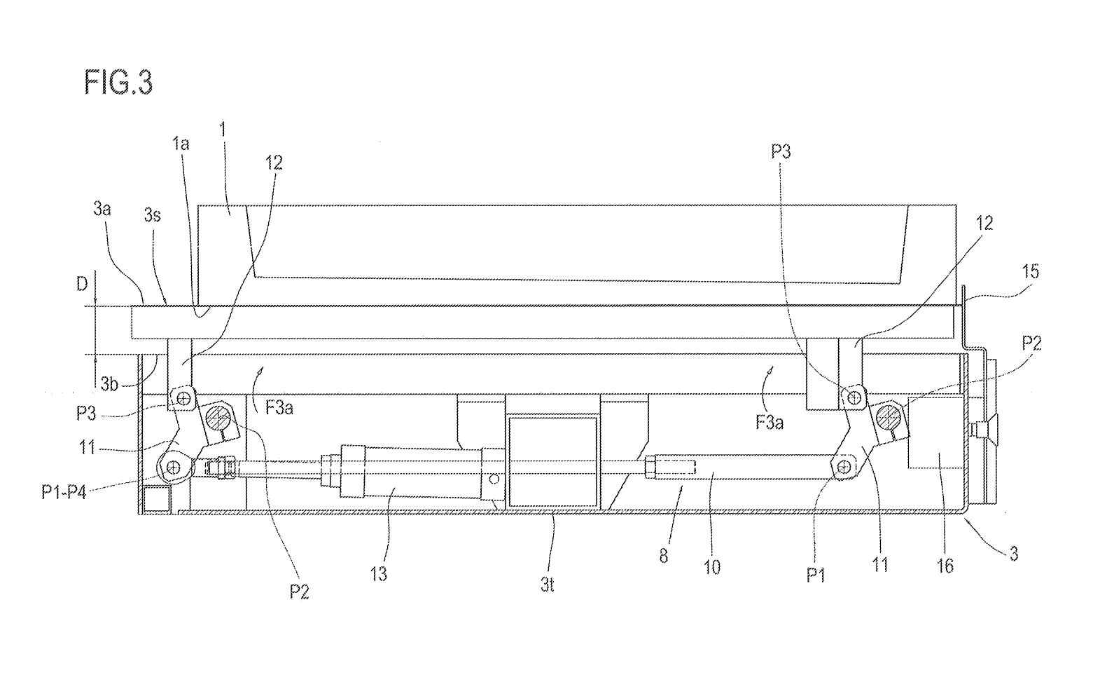

dividing the contact surface 3s into two separate, matching portions 3a and 3b by moving its first portion 3a, which supports the product 1, away from its other portion 3b (see FIG. 3);

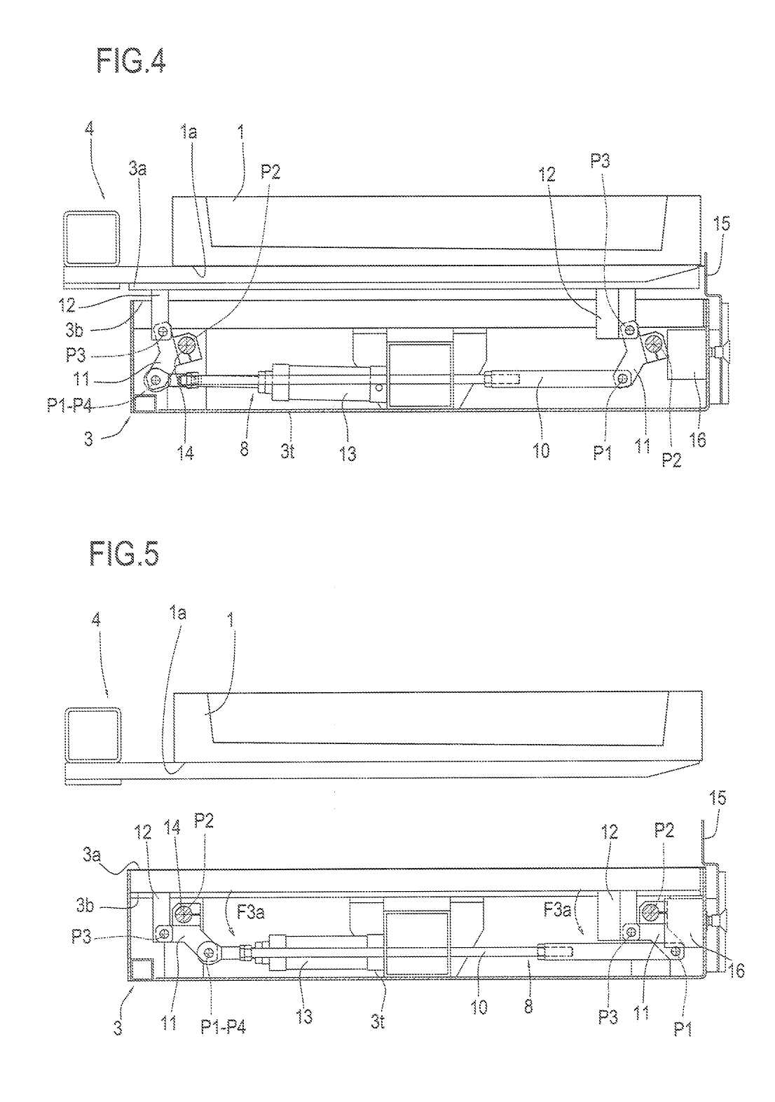

releasing the product 1 onto a work table and/or supporting element 4 matchingly shaped to be coupled to the first portion 3a of the extractor element 3 (see FIG. 4); and

moving the first portion 3a and the supporting element or work table 4 away from each other (see FIG. 5).

In this sequence of steps, the product 1 is picked up from the first portion 3a by moving the supporting element or work table 4 first towards and then away from the extractor element 3 since the first portion 3a is not, in the first embodiment illustrated, entirely separable from the second portion 3b.

FIG. 9, on the other hand, illustrates another embodiment of the method (and apparatus) according to the invention, where between the step of dividing the contact surface 3s and the step of releasing the product 1 there is a further step of totally separating and moving the first portion 3a, with the product 1 on it, away from the second portion 3b by means of a respective movement unit 5.

In this second embodiment, the movement unit 5 transports the first portion 3a to the work table or element 4.

Obviously, after the step of releasing the product 1 on the supporting element or work table 4, there is a step of transferring and moving the first portion 3a away from the supporting element or work table 4 so that it can be moved back towards the second portion 3b to allow another demolding operation to be carried out.

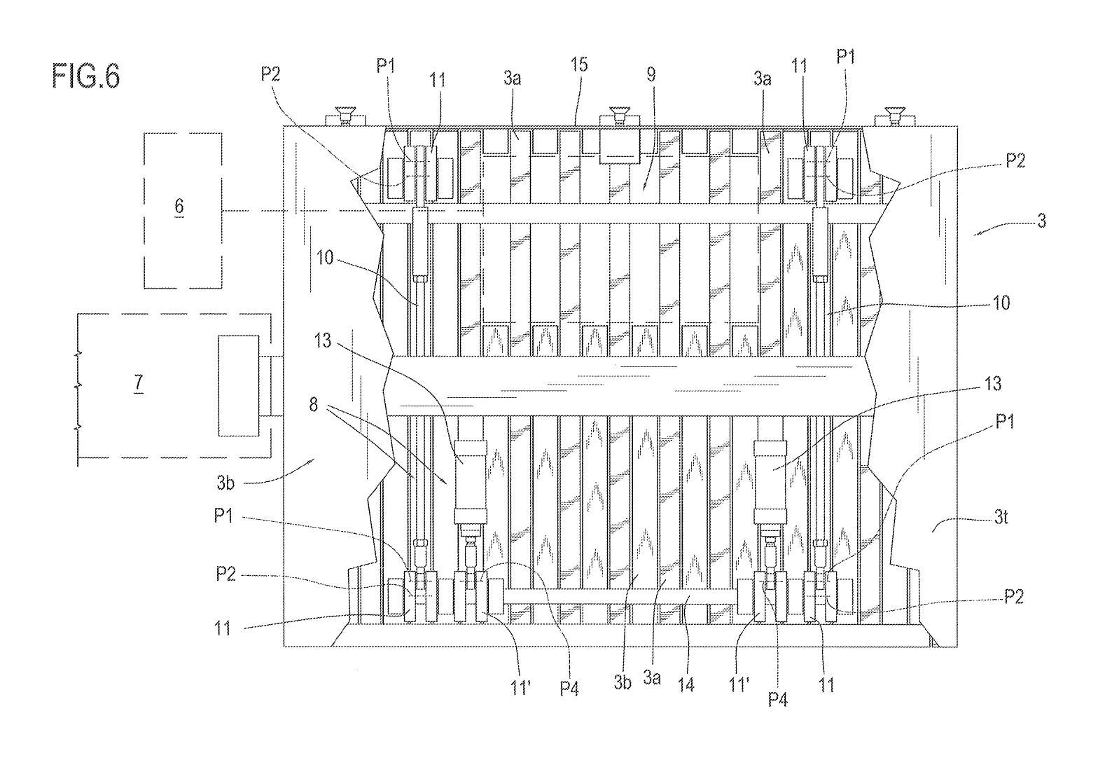

Demolding itself can be accomplished by creating a vacuum applied through the contact surface 3s by respective means 6 located on the second portion 3b and used to generate a negative pressure (said means being of customary type and therefore schematically represented as a block drawn with a continuous line in FIG. 6).

FIGS. 1 and 2 illustrate the sequence of steps for positioning the extractor element 3 and demolding the product 1 if the mold half-part 2 and the product 1 inside it are in a vertical position.

In this case, demolding is accomplished by positioning the contact surface 3s vertically, creating a vacuum applied through the contact surface 3s (again by the means 6 for generating a negative pressure), and then rotating the extractor element 3 in such a way as to move the contact surface 3s from the vertical position to a horizontal position to allow transfer (see arrow F3).

Obviously, after the step of moving the first portion 3a and the supporting element or work table 4 away from each other, there is a step of moving the two portions 3a and 3b towards each other so that they interpenetrate and once again form a substantially uninterrupted contact surface 3s allowing another demolding operation to be carried out.

Thus, to implement this method for demolding and transferring the ceramic product 1, the apparatus according to the invention comprises the above mentioned extractor element 3 which mainly comprises (see FIGS. 1 to 6):

the above mentioned first portion 3a, which is mobile relative to the second portion 3b, and which forms a part of the surface 3s that comes into contact with the visible surface 1a of the product 1;

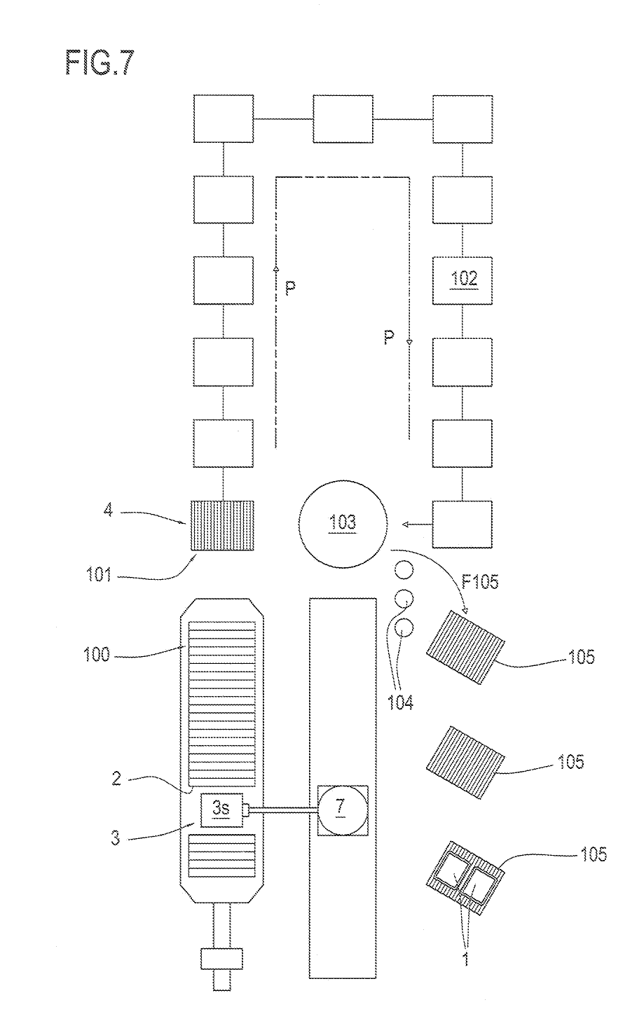

the second portion 3b, supporting the first portion 3a, interpenetrated with the first portion 3a to form the remaining part of the contact surface 3s, and constituting an operating end of a first movement unit 7 (illustrated schematically and drawn with a dashed line in FIGS. 6 and 7) with which it is associated; and

movement means 8 acting at least on the first portion 3a and designed to enable the first portion 3a to move relative to the second portion 3b, between a first working position for demolding the product 1, where the first portion 3a is in contact with and at least partly interpenetrates the second portion 3b, and a second working position for releasing the product 1, where the first portion 3a is away from the second portion 3b, to allow the product 1 to be transferred onto a matching supporting element or work table 4.

More specifically, the first mobile portion of the extractor element 3 is substantially composed of a rigid table 3a in the form of a series of parallel bars alternated with corresponding empty spaces to form a sort of fork.

The second supporting portion, on the other hand, is composed of a first upper part 3b in the form of a series of parallel bars alternated with corresponding empty spaces to form a sort of fork matching the first portion 3a, and a second part or frame 3t that can be associated with the first movement unit 7.

The first movement unit 7 may be of the robot- or servo-controlled type, depending on installation requirements.

Associated with the frame 3t are the vacuum generating means 6 leading into the frame 3t, which forms a chamber.

As mentioned above, the means 6 are illustrated as a block since they are of customary type and do not strictly fall within the scope of the invention.

For effective gripping and extraction, the first part or fork 3b has formed on it an opening or window 9, facing the first portion 3a, to allow the vacuum to pass from the above mentioned chamber to the surface 1a of the product 1, in such a way as to come into contact with and hold the product 1 (the perimeter of the opening is drawn with a dashed line in FIG. 6).

In the first embodiment illustrated, the above mentioned movement means 8 may comprise an articulated parallelogram system located on the second portion 3b (supported by the frame 3t), and acting on the first portion 3a, in such a way as to allow the first portion 3a to move from the first working position to the second and vice versa (see arrows F3a).

The articulated parallelogram system comprises: a pair of rods 10, respective crank levers 11 connected to the ends of the rods 10, at least one pair of bars 12 for each crank lever 11 and drive cylinders 13.

More in detail (see also FIG. 6), the two rods 10 are parallel to each other and each is hinged at one end, at a first point P1, to the respective crank lever 11.

Each crank lever 11 is connected, at a second point P2, at a bottom surface of the second portion 3b.

Each crank lever 11 is also hinged, at a third point P3, to the corresponding drive bar 12 associated with the first portion 3a in such a way that it can be lifted and lowered relative to the second portion 3b.

Two of the crank levers 11 are driven by the drive cylinders 13 which, as will become clearer below, are connected at a respective fourth hinge point P4 positioned in parallel with the first hinge point P1, in such a way that the first portion 3a can be lifted and lowered relative to the second portion 3b.

The two crank levers 11 located on the side of the cylinders 13 are connected to each other by being keyed to a single cylindrical bar 14 defining the second hinge point P2 on the second portion 3b.

Also keyed to the cylindrical bar 14 are two further crank levers 11′ connected to the cylinders 13, in such a way as to coordinate the movement of the articulated parallelogram with an upstroke designed to create a distance D between the two portions 3a, 3b such as to permit interposition of the matching supporting element or work table 4 in order to transfer the product 1 supported by the first portion 3a, which at that moment is in the raised position.

The supporting element or work table 4 comprises a series of parallel bars alternated with empty spaces to form a sort of fork matchingly shaped to be coupled to the first portion 3a.

Obviously, the element 4 might comprise a stable pronged work table on which the demolded product 1 can be rested and from which, as we shall see below, the product is made to advance first towards finishing stations and then towards pronged carriages on which the products 1 are allowed to dry.

The extractor element 3 also comprises a bracket 15 located at one end of the second portion 3b. The bracket 15 protrudes beyond the first portion 3a and the second portion 3b to form a bottom wall positioned perpendicularly with respect to the contact surface 3s formed by the two portions 3a and 3b: the bracket 15 supports the product 1 from below during its demolding, especially when demolding is performed vertically.

It should be noticed, in connection with the bracket 15, that the above mentioned articulated parallelogram system allows the first portion 3a to be lifted and simultaneously moved away from the bracket 15, thus preventing interference and scraping against the surface or edge of the product 1 located at the bracket 15 itself.

Further, the bracket 15 may be engaged by locking means 16 located on the second portion 3b and designed to enable the bracket 15 itself to be substituted: in this way, the contact surface 3s may be adapted to the different sizes of the products 1 to be demolded.

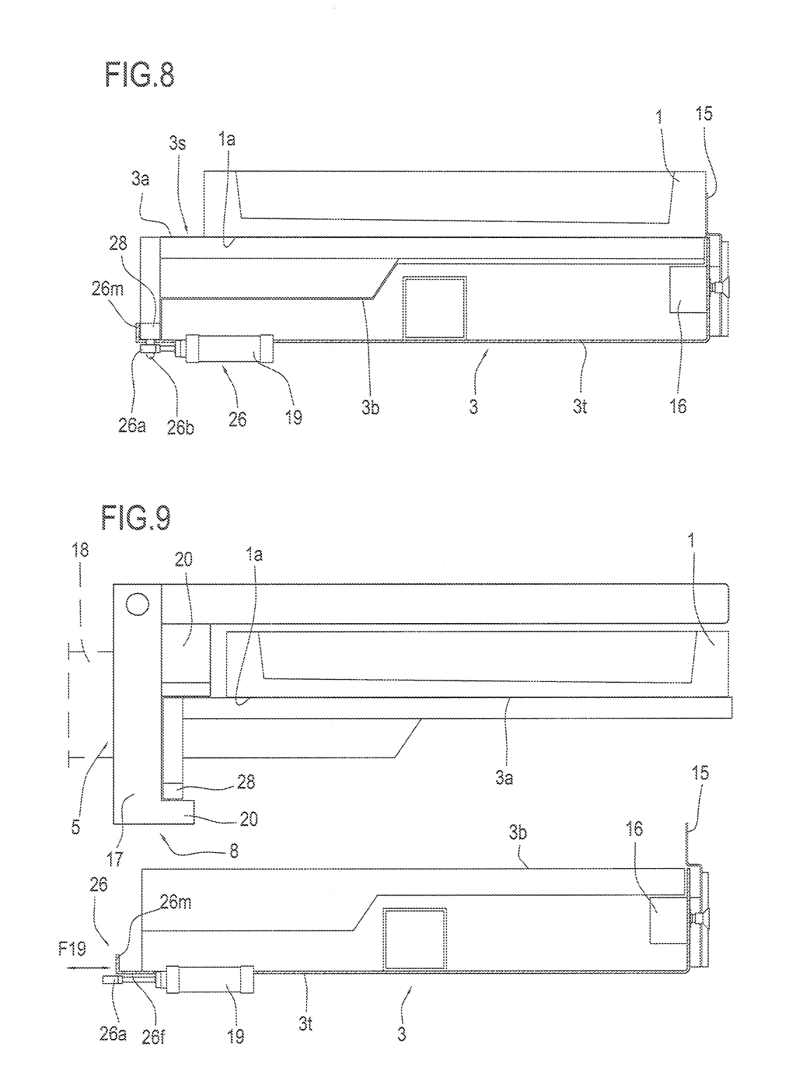

FIGS. 8 and 9 illustrate another embodiment of the extractor element 3 which basically comprises operating portions 3a and 3b with the same structure as the one just described but differing in that the first portion 3a can be separated completely from the second portion 3b using different movement means 8 of appropriate type.

In this second embodiment, the movement means 8 comprise means 26 for attaching/detaching the first portion 3a to/from the second portion 3b, and an external gripping unit 5 associated, if necessary, with a second unit 18 (of robotic or servo-mechanical type) acting on the first portion 3a in such a way as to move it away from the second portion 3b.

The attachment/detachment means 26 may, for example, comprise at least one pair of pins 26b located on a bottom end of the first portion 3a. The pins 26b may be accommodated in respective sockets or slotted holes 26f made in an end bracket 26m of the second portion 3b.

When the pins 26b are housed in place, the parts of them protruding downwardly to the bracket 26m are locked or released by respective hooks 26a associated with respective drive cylinders 19 connected at the bottom to the second portion 3b (see arrows F19).

The gripping unit 5, on the other hand, may for example comprise a carriage 17 for moving the first portion 3a and being equipped with at least one pair of clamping elements 20 designed to at least clamp bottom lateral protrusions 28 of the first portion 3a (projecting from the second portion 3b) and the top end zone of the first portion 3a in such a way as to transport the latter to a stable position at the supporting element or work table 4 which comprises a series of parallel bars alternated with empty spaces to form a sort of fork matchingly shaped to be coupled to the first portion 3a.

As mentioned above, therefore, the supporting element or work table 4 may simply be a pronged work table used only to transfer the product 1 from the first portion 3a and, if necessary, to support it stably while it dries, or a pronged work table driven, for example, by chain conveyor means which transport it along a predetermined path to allow finishing operations to be carried out on the product immediately (pronged conveyor).

An example installation is illustrated schematically in FIG. 7 and comprises: a multi-mold machine 100 for casting products 1 and operated on by the first movement unit 7 (in this case robotic) on which the extractor element 3 is mounted.

After demolding the product 1, the first robotic unit 7 may move to a station 101 for transferring the product and where the above mentioned supporting element or work table 4 is located. Alternatively, the second movement unit 5 may release the first portion 3a from the second portion 3b and transport the first portion to the station 101 where, in this case too, the supporting element or work table 4 for transferring the product 1 is located.

This transporting operation may be performed in “masked” time, that is to say, while the multi-mold machine is moving the half-molds to enable another demolding operation to be carried out.

Alternatively, at least in the first case, another robotic unit might be used to move the fork 4 close to the extractor element 3 so as to be able to transfer the product 1 immediately after demolding and close to the half-molds 2.

The product 1 is then transported along a path P by a suitable pronged conveyor 102 until it reaches a product 1 finishing station 103 equipped with suitable finishing tools 104.

At this point, the product 1 can be placed on appropriate fixed multi-level pronged carriages 105 for the predetermined length of time required for drying (see arrow F105).

A method and apparatus as described above therefore achieves the above mentioned aims thanks to the particular architecture and to the sequence of steps of moving the extractor element, enabling the product to be demolded or extracted from the mold and to place it on transferring and finishing tables immediately after demolding.

This eliminates the need for a traditional tray for each product demolded, thus reducing warehousing costs for the trays and the platforms used to support them and thus also reducing the overall dimensions of the installation.

The extractor made in this way is compact and can be operated by traditional robotic units.

As already mentioned, the possibility of immediately transferring the products thanks to the structure of the extractor improves the output capacity of production installations, reducing the working times required for finishing using mainly existing equipment and at the same time improving the end quality of the products.

The invention described above is susceptible of industrial application and may be modified and adapted in several ways without thereby departing from the scope of the inventive concept. Moreover, all the details of the invention may be substituted by technically equivalent elements.

1. A demolding method for extracting a ceramic product (1) from a half-part (2) of a mold, comprising at least the following steps:
positioning an extractor element (3), which has a contact surface (3s), at a visible surface (1a) of the product (1) partially housed in the mold half-part (2);
extracting the product (1) and placing it in abutment against the contact surface (3s);
dividing the contact surface (3s) into two separate, matching portions (3a, 3b) by moving a first portion of it (3a), which supports the product (1), away from its other portion (3b);
releasing the product (1) onto a work and/or supporting element or table (4) matchingly shaped to be coupled to the first portion (3a) of the extractor element (3);
moving the first portion (3a) and the supporting element or work table (4) away from each other.

2. The method according to claim 1, wherein, between the step of dividing the contact surface (3s) and the step of releasing the product (1), there is a step of totally separating and moving the first portion (3a), with the product (1) on it, away from the second portion (3b) by means of a respective movement unit (5).

3. The method according to claim 1, wherein, after the step of releasing the product (1) on the supporting element or work table (4), there is a step of transferring and moving the first portion (3a) of the extractor element (3) away from the supporting element or work table (4).

4. The method according to claim 1, wherein demolding is accomplished by creating a vacuum applied through the contact surface (3s) by means (6) for generating a negative pressure, located on the second portion (3b).

5. The method according to claim 1, where the mold half-part (2) holding the product (1) is positioned vertically, wherein demolding is accomplished by creating a vacuum applied through the contact surface (3s) by means (6) for generating a negative pressure, located on the second portion (3b).

6. The method according to claim 5, wherein, after the demolding step, there is a step of rotating the extractor element (3) in such a way that the contact surface (3s) moves from a vertical position to a horizontal position.

7. The method according to claim 1, wherein, after the step of moving the first portion (3a) and the supporting element or work table (4) away from each other, there is a step of moving the two portions (3a, 3b) towards each other so as to interpenetrate and once again form a substantially uninterrupted contact surface (3s).

8. A demolding apparatus for extracting a ceramic product (1) from a half-part (2) of a mold in which the product (1) is partly housed, the latter having a visible surface (1a), comprising an extractor element (3) in turn comprising at least:
a first portion (3a) forming a part of the surface (3s) that comes into contact with the visible surface (1a) of the product (1);
a second portion (3b), supporting the first portion (3a), interpenetrated with the first portion (3a) to form the remaining part of the contact surface (3s), and constituting an operating end of a first movement unit (7) which it is associated with;
movement means (8) acting at least on the first portion (3a) and designed to enable the first portion (3a) to move relative to the second portion (3b), between a first working position for demolding the product (1), where the first portion (3a) is in contact with and at least partly interpenetrates the second portion (3b), and a second working position for releasing the product (1), where the first portion (3a) is away from the second portion (3b), to allow the product (1) to be transferred onto a matching supporting element or work table (4).

9. The apparatus according to claim 8, wherein the first portion comprises a rigid table (3a) in the form of a series of parallel bars alternated with corresponding empty spaces to form a sort of fork.

10. The apparatus according to claim 8, wherein the second portion comprises a first upper part (3b) in the form of a series of parallel bars alternated with corresponding empty spaces to form a sort of fork matching the first portion (3a), and a second part or frame (3t) that can be associated with the first movement unit (7).

11. The apparatus according to claim 10, wherein associated with the frame (3t) there are vacuum generating means (6) leading into the frame (3t), which forms a chamber; the first part (3b) or fork having formed on it an opening or window (9), facing the first portion (3a), for the passage of the vacuum in such a way as to come into contact with and pick up the product (1).

12. The apparatus according to claim 7, wherein the movement means (8) comprise an articulated parallelogram system located on the second portion (3b) and acting on the first portion (3a), in such a way as to allow the first portion (3a) to move from the first working position to the second and vice versa.

13. The apparatus according to claim 7, wherein the articulated parallelogram system comprises: a pair of parallel rods (10), hinged at one end, at a first point (P1) of respective crank levers (11) connected, at a second point (P2), at a bottom surface of the second portion (3b); said crank levers (11) being also hinged, at a third point (P3), to respective drive bars (12) associated with the first portion (3a) in such a way that the latter is lifted and lowered relative to the second portion (3b).

14. The apparatus according to claim 13, wherein at least two of the crank levers (11) are connected to drive cylinders (13) at a respective fourth hinge point (P4) positioned in parallel with the first hinge point (P1), said cylinders (13) enabling the first portion (3a) to be lifted or lowered relative to the second portion (3b).

15. The apparatus according to claim 14, wherein at least two of the crank levers (11) are connected to each other by being keyed to a single cylindrical bar (14) defining the second hinge point (P2) on the second portion (3b); there being also keyed to the cylindrical bar (14) two further crank levers (11′) connected to the cylinders (13), in such a way as to coordinate the movement of the articulated parallelogram with an upstroke designed to create a distance (D) between the two portions (3a, 3b) such as to permit interposition of the matching supporting element or work table (4) in order to transfer the product (1) supported by the first portion (3a).

16. The apparatus according to claim 7, wherein the supporting element or work top (4) comprises a series of parallel bars alternated with empty spaces to form a sort of fork matchingly shaped to be coupled to the first portion (3a).

17. The apparatus according to claim 7, wherein one end of the second portion (3b) is provided with a bracket (15) protruding beyond the first portion (3a) and the second portion (3b) to form a bottom wall positioned perpendicularly with respect to the contact surface (3s) formed by the two portions (3a, 3b) to support the product (1) from below.

18. The apparatus according to claim 17, wherein the bracket (15) is engaged by locking means (16) located on the second portion (3b) and designed to enable the bracket (15) to be securely positioned near the first portion (3a) and the second portion (3b) and to be substituted when necessary.

19. The apparatus according to claim 7, wherein the movement means (8) comprise means (26) for attaching/detaching the first portion (3a) to/from the second portion (3b), and an external gripping unit (5) associated with a second unit (18) acting on the first portion (3a) in such a way as to move it away from the second portion (3b).

20. The apparatus according to claim 19, wherein the attachment/detachment means (26) comprise at least one pair of pins (26b) located on a bottom end of the first portion (3a); it being possible to accommodate said pins (26b) in respective sockets or slotted holes (26f) made in an end bracket (26m) of the second portion (3b); an end portion of each pin (26b) protruding downwardly from the bracket (26m), when housed in the slotted holes (26f, being engageable by or releasable from respective hooks (26a) associated with respective drive cylinders (19) connected at the bottom to the second portion (3b).

21. The apparatus according to claim 19, wherein the external gripping unit (5) comprises a carriage (17) for moving the first portion (3a) and being equipped with at least one pair of clamping elements (20) designed to at least clamp, at the bottom, lateral protrusions (28) of the first portion (3a) and, at the top, an end zone of the first portion (3a) in such a way as to transport the latter to the supporting element or work table (4) which comprises a series of parallel bars alternated with empty spaces to form a sort of fork matchingly shaped to be coupled to the first portion (3a).
